(19) United States
(12) Patent Application Publication
(10) Pub. No.: US 2019/0077327 A1
(43) Pub. Date: Mar. 14, 2019

(54) Vehicle Mounted Folding Ladder Rack

(71) Applicant: The Knapheide Manufacturing Company, Quincy, IL (US)

(72) Inventors: Jyotirmoy Saha, Quincy, IL (US); Lucas Creasy, Scottsdale, AZ (US); Rahul Sonkul, Quincy, IL (US)

(73) Assignee: The Knapheide Manufacturing Company, Quincy, IL (US)

(21) Appl. No.: 15/704,184

(22) Filed: Sep. 14, 2017

(51) Int. Cl. B60R 9/042

(52) U.S. Cl. CPC B60R 9/0423

(57) ABSTRACT

Various embodiments of a foldable truck mounted ladder rack are disclosed that provide a user with increased leverage so as to reduce the effort required to access a ladder stowed on the ladder rack. The ladder rack folds between a stowed position on top of the utility vehicle to a deployed position over the side of the vehicle. The foldable truck mounted ladder rack includes four movable link arms and five pivot points, making it easier to load and unload a ladder. When the ladder rack module reaches the tipping point between the stowed position and the deployed position gravity takes over and the user is no longer required to exert effort to continue opening the ladder rack module. Upon reaching the tipping point the ladder rack module will simply drop into the deployed position. A damping cylinder is provided to control the speed at which the ladder rack module drops from the tipping point into the deployed position.

### BACKGROUND

### Field of the Invention

The present invention relates to vehicle mounted racks for transporting objects, and more specifically to roof mounted ladder rack systems and methods of using and making them.

### Description of Related Art

There are a number of different types of vehicles specifically designed to haul tools, building materials and other various objects. Such vehicles include utility trucks, panel vans, sport utility vehicles (SUVs), jeeps, pickup trucks and the like. However, it is difficult to haul ladders in such vehicles, or other objects and building materials that may be longer than the cargo area. Utilizing the space on the roof of the vehicle offers a solution in this regard. One solution has been to provide a roof mounted cargo rack to carry long items such as ladders, pipes or other materials too long to fit in the cargo bay. There are some conventional designs of ladder racks existing today that have the capability of folding down over the side of the vehicle to make it easier to access the ladder.

### SUMMARY

The present inventors recognized a need for a roof mounted ladder rack that provides increased leverage, making it easier to load and unload heavy ladders and other objects from vehicles with various roof profiles.

Various embodiments disclosed herein address the above stated need by providing new and novel design for a ladder rack system for stowing a lengthy object such as a ladder on a wheeled vehicle. The ladder storage rack includes first and second modules for holding the first and second ends of the ladder. Each of the ladder storage rack modules also include at least four module link arms that are connected to at least five module rotation points. Two of the rotation points on each module—the two end points of the connected link arms—are part of a housing that is affixed to the vehicle. The ladder storage rack also has a rotatable tube that connects the first module to the second module, and a torque arm that is configured to be connected to the rotatable tube.

### BRIEF DESCRIPTION OF THE DRAWINGS

The accompanying drawings, which are incorporated in and constitute part of the specification, illustrate various embodiments of the invention. Together with the general description, the drawings serve to explain the principles of the invention. In the drawings:

FIG. 1A depicts a side view of one assembly according to various embodiments of the ladder rack disclosed herein.

FIG. 1B depicts a ladder rack embodiment with mechanically identical front and rear modules.

FIGS. 2A-B each depict oblique views of a ladder rack embodiment mounted on a vehicle. FIG. 2A depicts the stowed configuration and FIG. 2B depicts the deployed configuration.

FIG. 3 depicts side views, taken from the rear of a vehicle, of the ladder rack being moved from the stowed position to the deployed position according to two different embodiments of the ladder rack disclosed herein.

FIG. 4 depicts an oblique view of a ladder rack implemented with a slide mechanism according to various embodiments of the ladder rack disclosed herein.

FIGS. 5A-5B depict a ladder rack model as seen from a side view in the stowed position and in the deployed position showing the variable names for mathematical relationships that defines the motion of the device.

FIGS. 6A and 6B provide two flowcharts for a method of using a ladder rack system according to various embodiments disclosed herein.

### DETAILED DESCRIPTION

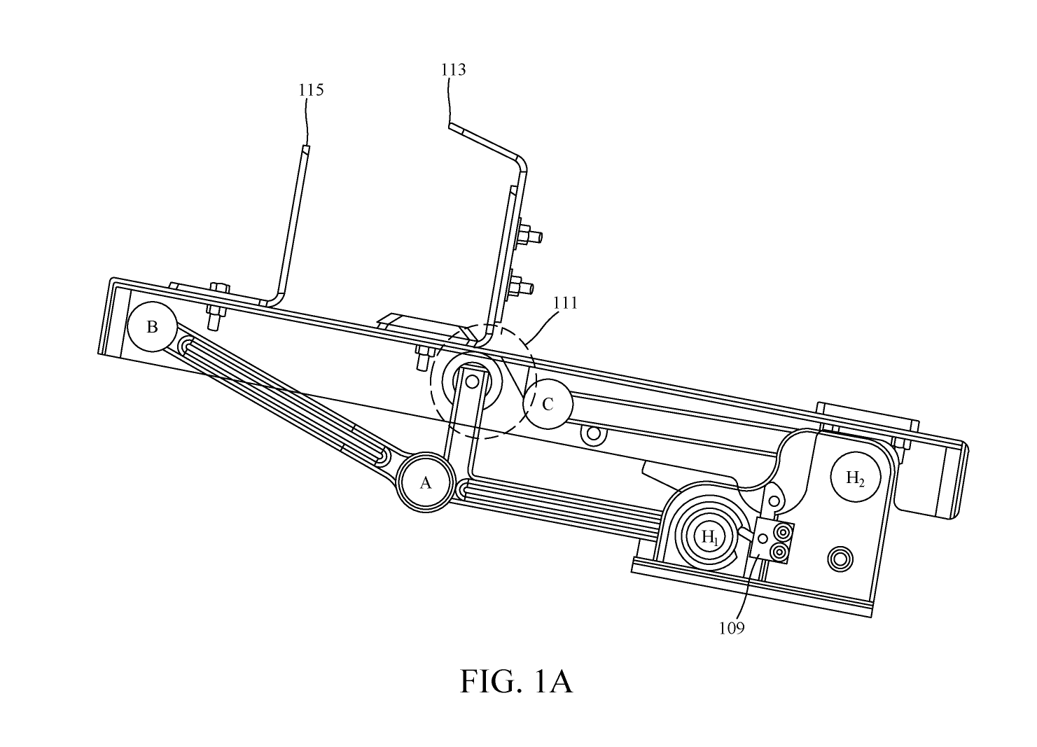

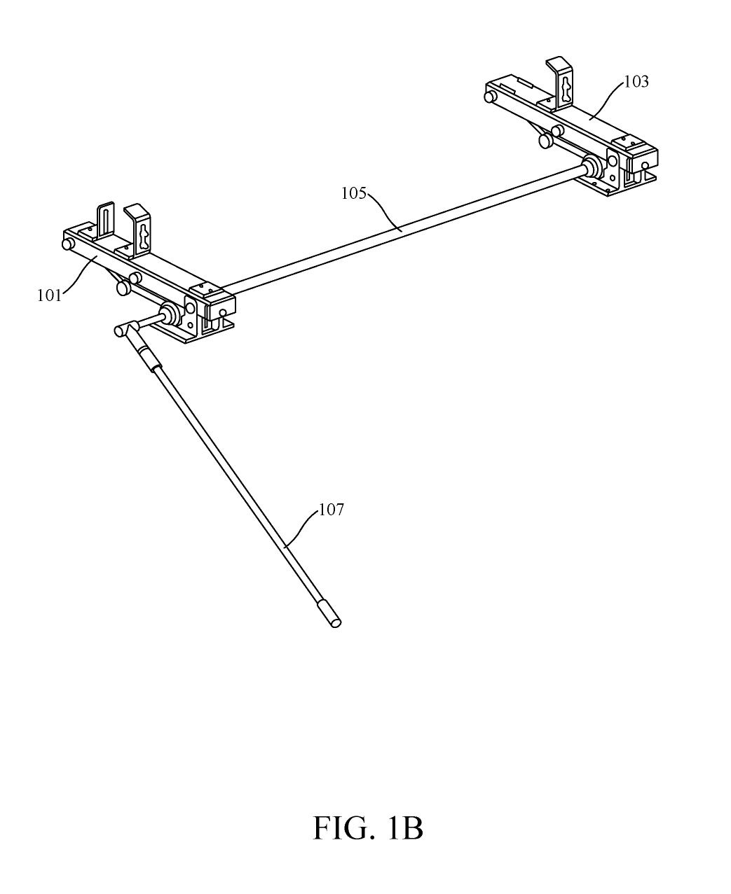

FIG. 1A depicts a side view of one assembly according to various embodiments of the ladder rack disclosed herein. In various embodiments the ladder rack includes two or more modules that have similar mechanical properties that, together, hold items securely on top of the vehicle. FIG. 1A illustrates a single module constructed of four rotatable link arms labeled L1, L2, L3 and L4. The four link arms are rotationally constrained by their lengths and by the fixed rotational connection points H₁ and H₂. In various embodiments the fixed rotational connection points H₁ and H₂ are found on a housing. The housing is stationary with respect to the body of the vehicle, for example, by virtue of being mounted on the vehicle's roof or other upper part of the vehicle. Some embodiments feature multiple fixed housings, for example, two fixed housings for each module—one housing for H₁ and another housing for H₂. In yet other embodiments the two modules may share a single housing that spans the distance between the modules. The pivot points A, B, C, H₁ and H₂ have rotational elements—e.g., bearings—to effect the relative rotation of the link arms. In at least some embodiments the cross-section of link arm L3 is U shaped, allowing link arm IA to fold underneath and into the cavity of link arm L3 in the stowed position.

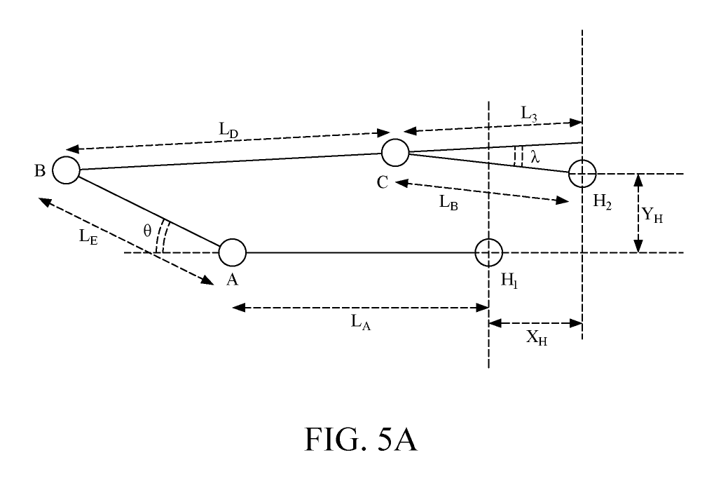

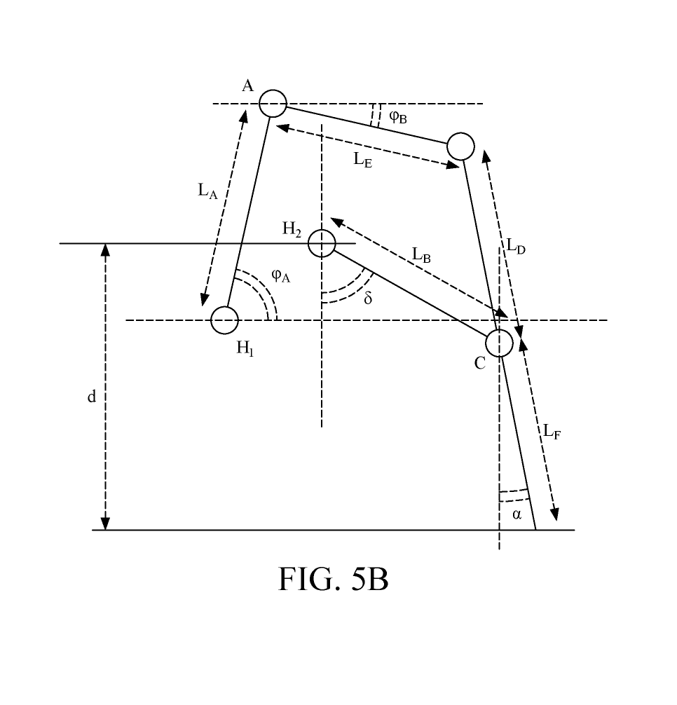

The structural link arm components L1, L2, L3 and L4 are connected in series. The end points of this link arm series—an end point of link arm L1 and an end point of link arm L4—are rotatably connected to the two fixed rotation points H₁ and H₂. That is, an end of link arm L1 is rotatably connected to fixed rotation point H₁ and an end of link arm L4 is rotatably connected to fixed rotation point H₂. By “rotatably connected” it is meant that the link arms are securely connected at points A, B, C, H₁ and H₂, but are able to rotate about an axis at the connection points. A number of mechanisms may be used to rotatably connect two parts with negligible friction, including for example, a roller bearing or ball bearing, a hinge, a pin fitted through a hole or sleeve, or the like. By “fixed rotation points” it is meant that H₁ and H₂ secured (fixed) to the vehicle but allow the connected link arms L1 and L4 to rotate about the fixed rotation points H₁ and H_{z}, respectively. That is, the rotation points H₁ and H₂ themselves do not move in space in relation to each other, or in relation to the vehicle, since fixed rotation points H₁ and H₂ are secured to the stationary housing. Link arm L3 is typically not connected to the end of link arm L4. Instead, link arm L3 is connected at a point towards the center (but not necessarily in the exact center) of link arm L4. This may be seen in FIG. 5B where link arm L4 is labeled in the figure as having a length L_{B} and link arm IA is labeled as having a length of L_{D} plus L_{F}.

The other three rotation points A, B and C allow the adjacent link arms to rotate relative to each other. The three rotation points A, B and C are not fixed rotation points since A, B and C move in space as the ladder rack module moves back and forth between the stowed position and the deployed position. The three rotation points A, B and C are “deployable rotation points.” To operate (deploy/stow) the ladder rack the manual torque is applied at point H₁ through a torque arm. The lift off mechanism reduces the manual torque as the ladder rack is activated for deploying and prevents any lockup of the mechanism.

Various embodiments of the ladder rack have a reflex locking mechanism 109. The reflex locking mechanism 109 is a latch that secures the ladder rack in place upon reaching the stowed position. In various embodiments the user does not need to engage or disengage the reflex locking mechanism 109. Instead, the reflex locking mechanism 109 engages in response to the ladder rack reaching the stowed position. When the user wants to remove a ladder from the vehicle, the reflex locking mechanism 109 disengages in response to the user manipulating the torque arm to deploy the ladder rack. The initial rotation of the torque arm (e.g., about 10°) solely effects the unlocking of the latch of the reflex locking mechanism.

A lift off mechanism 111 is provided on various embodiments of the ladder rack. The lift off mechanism 111 aids in deploying the ladder rack by applying force towards the center of link arm L3 thereby reducing the torque to actuate the ladder rack. Without the lift off mechanism 111 all the force resulting from the user rotating the torque arm would be transferred through link arms L1 and L2 to the rotational point H2. The lift off mechanism 111 increases the user's leverage, making it easier to deploy the ladder rack. The lift off mechanism 111 applies force at points towards the center of link arm L3, rather than applying force solely at rotational point B where link arm L3 connects with link arm L3. The lift off mechanism 111 is attached to link arm L1 and has a roller that contacts link arm L3. As the module hinges upward during deployment, the roller of lift off mechanism 111 rolls (tangentially) along link arm L3 until the link arm L3 lifts away from it due to the hinging action at rotational points A and C.

In various embodiments a ladder restraining bracket 113 is provided on both the front and rear ladder rack modules, while only the rear ladder rack module has an additional ladder restraining bracket 115. The user hangs the ladder on the ladder restraining brackets 113 of both the front and rear modules while the ladder rack is in the deployed position. In some embodiments the ladder restraining bracket 115 is also provided on the rear module. It has been found that the ladder restraining bracket 115 helps to prevent damaging the vehicle's mirror while the user is inserting a ladder into the ladder rack by discouraging the user from lifting the ladder higher than the rear module. Typically, the user places the top end of the ladder into the front ladder rack module, then lifts the bottom end of the ladder into the rear module. However, if the user lifts the bottom end of the ladder too high while inserting it into the ladder rack rear module the top end of the ladder can hinge into the vehicle's mirror, damaging it. The ladder restraining bracket 115 prevents a user from hinging the ladder too far upward while being inserted, thus preventing possible damage to the vehicle's mirror. To distinguish the two types of brackets the ladder restraining bracket 115 is called an upper ladder restraining bracket 115. The ladder restraining bracket 113 is called a lower ladder restraining bracket 113.

Some of the various ladder rack embodiments utilize motorized rotation instead of manual rotation. In such embodiments a motor and drive train or chain mechanism is used rotate the ladder rack by applying torque at fixed rotation point H₁. The ladder rack motor may be tied into the vehicle's electrical system, and/or may have a battery or other power source dedicated to the ladder rack mechanism. In such embodiments a motor control, e.g., a switch, is provided for the user to raise and lower the ladder rack.

FIG. 1B depicts a full ladder rack assembly with two mechanically identical modules—a front module 103 and a rear module 101. The rear module 101 is typically located towards the rear of the vehicle with the front module 103 being located further forward towards the front of the vehicle. The two or more modules 101-103 are installed on the top of the vehicle to hold a ladder or other long item in place on the vehicle's roof. The torque arm 107 is manipulated by a user to manually actuate the ladder rack. Manual torque is directly applied to the rear module and the torque arm is coupled to the front module via a connecting tube 105. The connecting tube 105 may be either hollow or solid. A typical ladder rack assembly has two modules, as shown in FIG. 1B, front module 103 and a rear module 101. However, long vehicles such as the trailer of an eighteen wheel truck may be equipped with a ladder rack embodiment employing three or more modules—e.g., one modules toward the front, one in the middle and one towards the rear.

The ladder rack modules 101 and 103 are generally installed near the side edge of the vehicle roof so as to allow the ladder rack to fold down over the side for ease of loading and unloading. In some implementations when multiple ladders or other materials are to be hauled, there may be two separate ladder rack systems installed on the same vehicle—one on the passenger's side and another on the driver's side.

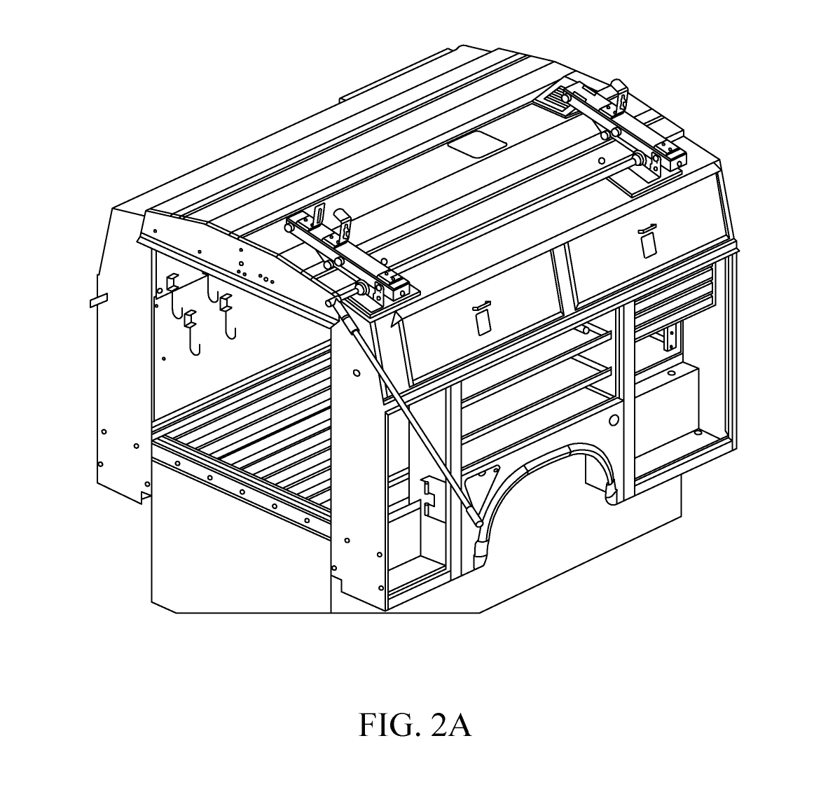

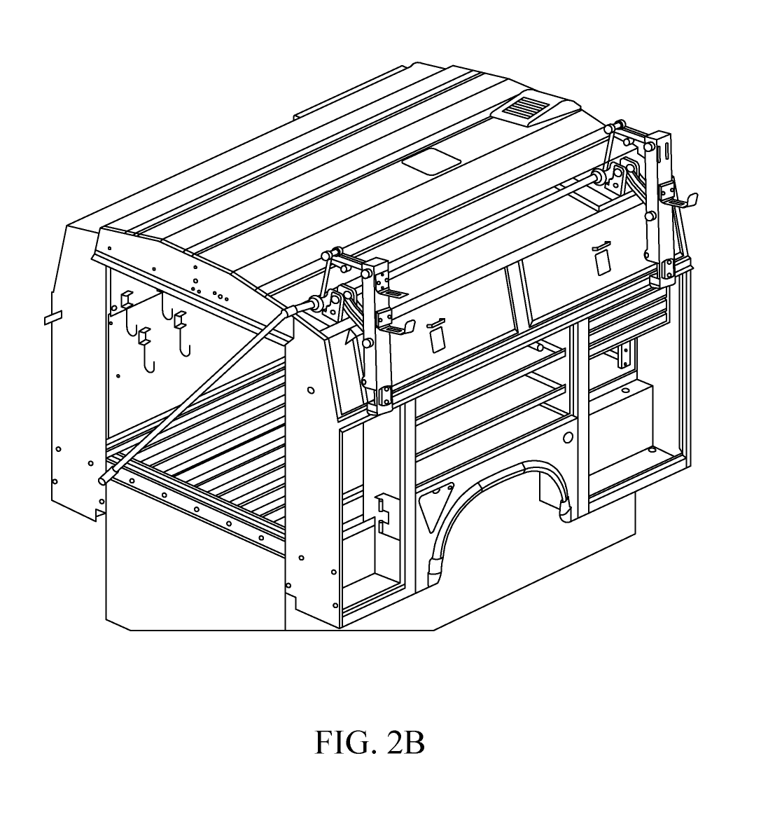

FIGS. 2A-B each depict oblique views of a ladder rack embodiment mounted on a vehicle. FIG. 2A shows the ladder rack modules in the stowed position suitable for securing a ladder (not shown) on the roof of the vehicle. FIG. 2B shows the ladder rack in the deployed position—that is, folded down—enabling convenient access to remove or replace the ladder along the side of the vehicle.

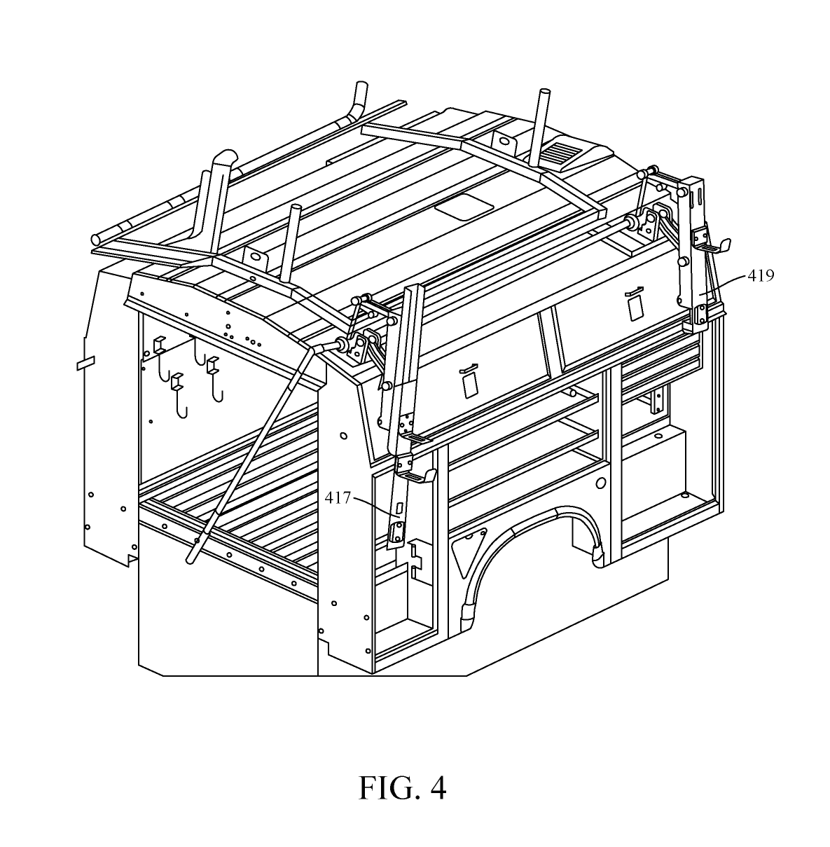

Embodiments of the ladder rack may be configured for vehicles of various sizes and shapes. FIGS. 2A-B illustrate a utility truck body that is commonly equipped with a ladder rack of the type disclosed herein. The top of a utility truck body as shown in FIGS. 2A-B is often approximately seven to nine feet from the ground. The ladder rack configured for such a vehicle may be adjusted to have a drop of approximately 14 inches. The “drop” (represented by the variable “d”) of the ladder rack is defined as the vertical difference between the fixed rotational connection point H₂ and the bottom edge or distal end of link arm L3 in the deployed (down) position. A slide mechanism may be used to lower the ladder down a further amount in addition to the drop. The slide mechanism is depicted in FIG. 4 and further discussed in the paragraphs below.

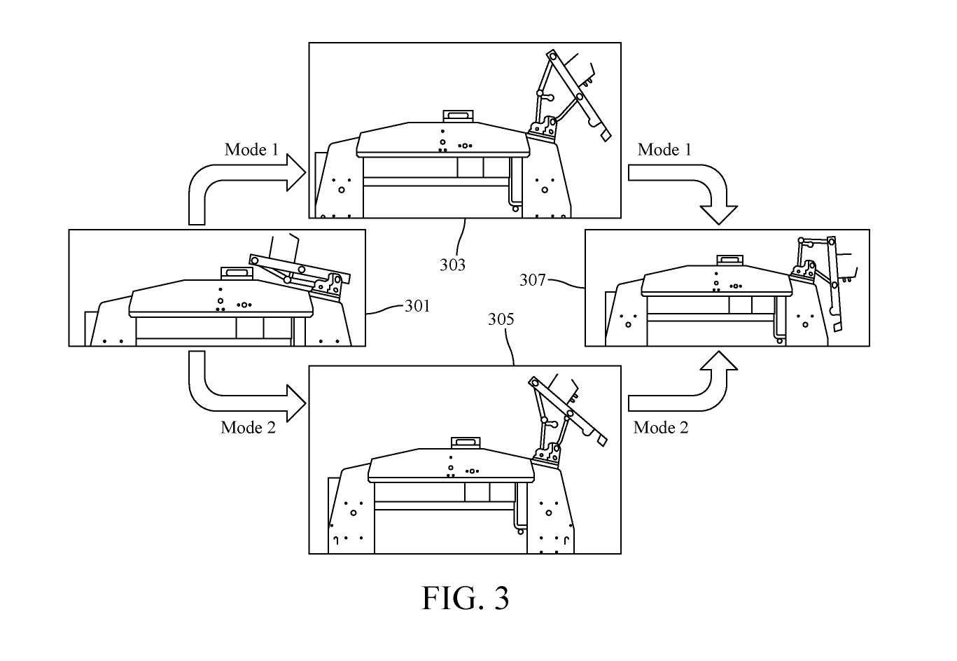

FIG. 3 depicts views of the ladder rack looking from the rear of the vehicle. The left view shows the ladder rack in the stowed position. The right view shows the ladder rack in the deployed position. The two center views 303 and 305 show the ladder rack in intermediate positions for both a 303 Mode 1 deployment and a 305 Mode 2 deployment, as it is being manipulated from the stowed position to the deployed position. The ladder rack can be engineered to deploy either via 303 Mode 1 or 305 Mode 2, as shown in figure. The 305 Mode 2 deployment typically requires lesser manual effort (force and therefore torque) as compared to the 303 Mode 1 deployment of the ladder rack. The configuration to implement 303 Mode 1 deployment differs from the 305 Mode 2 deployment inasmuch as 305 Mode 2 deployment features a ladder rack with an angle constraint mechanism between link arm L1 and link arm L2. The angle constraint mechanism inhibits link arm L2 from rotating until link arm L1 has been manually rotated to the tipping point. In essence, the angle constraint mechanism and the lift off mechanism 111 act in tandem to enable the 305 Mode 2 operation of the device.

The tipping point is the position of the ladder rack, along its trajectory as it is being deployed, beyond which the force of gravity acts to continue rotating the ladder rack into the deployed position. The ladder rack module is at a balanced, torque neutral position at its tipping point. That is, at the tipping point the sum of all forces and the sum of all torques is equal to zero and the system is at an unstable equilibrium. Upon slightly crossing the tipping point the ladder rack module will simply drop into the deployed position. As the ladder rack module passes the tipping point the force of gravity takes over and the user is no longer required to exert effort to continue opening the ladder rack module to the deployed position. However, if the user releases the ladder rack before the tipping point is reached, the ladder rack will settle back into the stowed position rather than continuing towards the stowed position.

Beyond the tipping point link arm L2 rotates under the influence of gravity—that is, beyond the tipping point the force of gravity takes over and link arm L2 falls into the deployed position. A damping device (e.g., a hydraulic damper) is provided to control the speed at which the ladder rack module drops from the tipping point into the deployed position. The rate of rotation (falling) past the tipping point is regulated by a hydraulic damper. The hydraulic damper arrests the motion of this fall during deploying the ladder rack.

Depending on the particular configuration, the parameters of a given assembly design may be tailored so that, upon reaching the tipping point, the center of gravity is at or beyond a vertical line bisecting fixed rotation point H1. By “beyond” it is meant in the direction from the stowed position towards the deployment position, that is, over the side of the vehicle. By “vertical line” it is mean a line passing through the center of earth through fixed rotation point H1. By “center of gravity” it is meant a point on the assembly where half of the weight of the assembly plus its load (ladder) is on either side of the center of gravity point—that is, half the weight is on one side and half the weight is on the other side.

The tipping point may be defined in a number of different, equivalent manners. For example, the tipping point can be described by the amount of rotation of link arm L1 about fixed rotation point H1. The tipping point can also be described as a particular point along the path of rotation of a given part of the assembly. For example, the tipping point may be reached upon the rotation point A between link arm L2 and link arm L3 reaching a certain point in its curvilinear path (or rotational path) as the ladder rack is manipulated from its stowed position to the deployed position.

FIG. 4 depicts an oblique view of a ladder rack implemented with front and rear slide mechanisms. In the figure the front slide mechanism 419 is shown in the contracted (up) position and the rear slide mechanism 417 is shown in the extended (down) position—sometimes called the deployed position. The slide mechanisms 417-19 may be considered a modified version of link arm L3. That is, the link arm L3 may be implemented to include a slide mechanism. Typically, if the link arm L3 has a slide mechanism, the ladder restraining brackets 113 and 115 depicted in FIG. 1A are mounted on the slide mechanism portion of link arm L3.

Slide mechanisms are especially useful for vehicles with roof heights in excess of seven feet from the ground. In some embodiments the slide mechanism can be up to as long as the length of link arm L3. Such embodiments are unobtrusive inasmuch as the slide mechanism does not extend much beyond link arm L3 over the top of the vehicle when in the slide mechanism is in the contracted position. The dimensions of the ladder rack may be tailored to suit the height of other vehicles, including vehicles much larger than that shown (e.g., eighteen wheeled trucks, marine vessels, train cars, etc.) or smaller than that shown (e.g., automobiles). In such embodiments an extra-long slide mechanism is available—even longer than the link arm L3. Such embodiments with extra-long slide mechanisms are available in lengths of up to the width of the vehicle. In the contracted position the extra-long slide mechanisms extend out over the top of the vehicle beyond the upper end of link arm L3 when the ladder rack is in the stowed position.

FIG. 5A depicts a model (illustration) of a ladder rack as seen from a side view in the stowed position showing the variable names, terms and parameters for mathematical relationships that describe the movement and structure of the device. FIG. 5B depicts a similar ladder rack model in the deployed position. FIGS. 5A-5B depict pivot points H₁ and H₂, and A, B and C. Pivot points H₁ and H₂ are fixed rotation points. Pivot points A, B and C are deployable rotation points. The length L_{A} is the distance between pivot points A and H₁ and depends on the length of link arm L1 as shown in FIG. 1A. L_{E} is the distance between pivot points A and B and depends on the length of link arm L2. L_{D} is the distance between pivot points B and C and depends on the length of link arm L3. L_{B} is the distance between pivot points C and H₂ and depends on the length of link arm L4. Y_{H} is the vertical distance between fixed rotation points H₁ and H₂. X_{H} is the horizontal distance between fixed rotation points H₁ and H₂.

FIG. 5B, which shows the ladder rack in the deployed position, illustrates the drop d of the ladder rack with the link arm L3 oriented vertically in the deployed position. In some embodiments the link arm L3 is substantially vertical when in the deployed position. In other embodiments the deployed orientation of link arm L3 may differ from the vertical direction by an angle α. The link arm L3 may be oriented at angle α in the deployment position to ease the loading or unloading of a ladder or other lengthy object. The drop is the vertical difference between the fixed rotational connection point H₂ and the bottom edge (distal end) of link arm L3 in the deployed (down) position as shown in FIG. 5B. Some embodiments are further configured with a slide mechanism to bring the height of the ladder down an additional amount, to a level below the stowed position less the drop. The height “h” of the ladder rack is the vertical distance between the lowest and highest points of the ladder rack when it is in the stowed position.

FIGS. 5A-5B depict a number of variables that represent angles and lengths of various ladder rack embodiments. The angles and lengths are used in the mathematical relationships provided below that describe the movement and structure of various ladder rack embodiments. For example, the angle θ is the angle between link arm L2 and a line extending from link arm L1 past pivot point A in the stowed position. The angle λ is the angle between link arm L3 and link arm L4 in the stowed position. The angle φ_{A} is the angle between link arm L1 and horizontal direction in the deployed position. The angle φ_{B} is the angle between link arm L2 and horizontal direction in the deployed position. The length L_{B} is the length of link arm L4. The angle δ is the angle between link arm L4 and the vertical direction in the deployed position. The variable d denotes the drop of the ladder rack which is the difference between the fixed rotational connection point H₂ and the bottom edge of link arm L3 in the deployed (down) position. The length L_{F} is the portion of link arm L3 that extends past rotation point C to the tip of link arm L3 (opposite the rotation point B). The length of link arm L3 is equal to the lengths L_{F} plus L_{D}. The variable α represents the angle between the vertical direction and the link arm L3 in the deployed position.

The following mathematical relationships M1 through M4 describe the movement and structure of various ladder rack embodiments disclosed herein:

L_{A} sin(φ_{A})+L_{B} cos(δ)−Y_{H}=L_{D}+L_{E} sin(φ_{B}) M1:

L_{A} cos(φ_{A})+L_{E} cos(φ_{B})=X_{H}+L_{D}+L_{B} sin(δ) M2:

L_{E} cos(θ)+L_{A}+X_{H}=L_{D}+L_{B} M3:

L_{E} sin(θ)=Y_{H} M4:

d=L_{B} cos(δ)cos(α)L_{F} M5:

One physical constraint of various embodiments is that the place holder for the ladder on link arm L3 is chosen such that the center of gravity of the system allows for a free fall (in essence a tipping point) during deployment and stowing beyond a set angle φ_{A}. Given the particular interconnection, the following characteristics C1) through C6) hold true for various embodiments of the ladder rack.
C1) Link arms L1-L4 are free to rotate about their pivot points, satisfying the minimal mathematical constraints at the two deployment positions.
C2) The location of the pivot points are evaluated by the minimal mathematical constraints optimizing the metrics—for example, optimizing the metric d in FIG. 5B. The length L_{F} (the outer end of link arm L4) is mathematically unconstrained.
C3) Angle locking constraints (θ, φ_{A} and δ) are dictated by the metrics and the curvature of the roof surface of the vehicle.
C4) The geometric structures of the links are not constrained to any particular shape or form so long as constraint C2) remains satisfied.
C5) H1 and H2 are fixed with respect to the vehicle roof surface. Manual torque is applied at H1 to actuate the ladder rack. The structure that houses pivot points H1 and H2 is referred to as the “housing.”
C6) To effect mode 1 for deployment of the ladder rack, angle λ can be set to zero such that link arm L4 is parallel to the horizontal direction. To effect mode 2 for deployment angle λ cannot be set to zero to avoid potential lockup during deployment of the ladder rack.

The various embodiments and implementations of the ladder rack were designed with three performance metrics P1) through P3) in mind:
P1) The variable h denotes the vertical distance between the lowest point (the bottom edge of the housing) and the highest point of the ladder rack in the stowed position. Various embodiments of ladder rack are designed to minimize the height h.

P2) The variable d denotes the drop of the ladder rack which is the difference between the fixed rotational connection point H₁ (near the bottom edge of the housing) and the bottom edge of link arm L3 in the deployed (down) position as shown in FIG. 5B. Various embodiments of ladder rack are designed to maximize the drop d.
P3) The angle φ_{A} is the angle through which manual torque is applied to change the position from deployed to stowed. Some of the various embodiments of ladder rack are designed to maximize the angle φ_{A}.

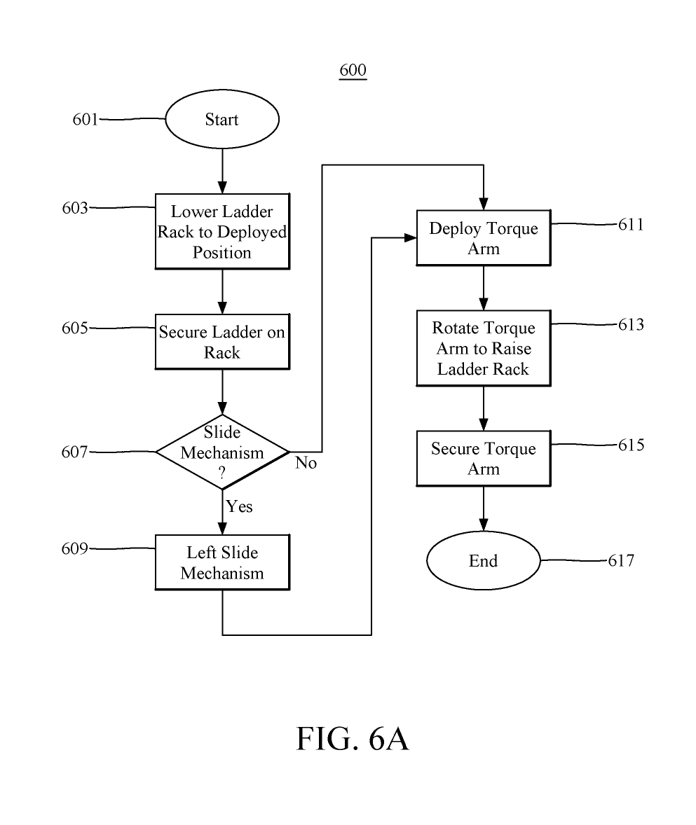

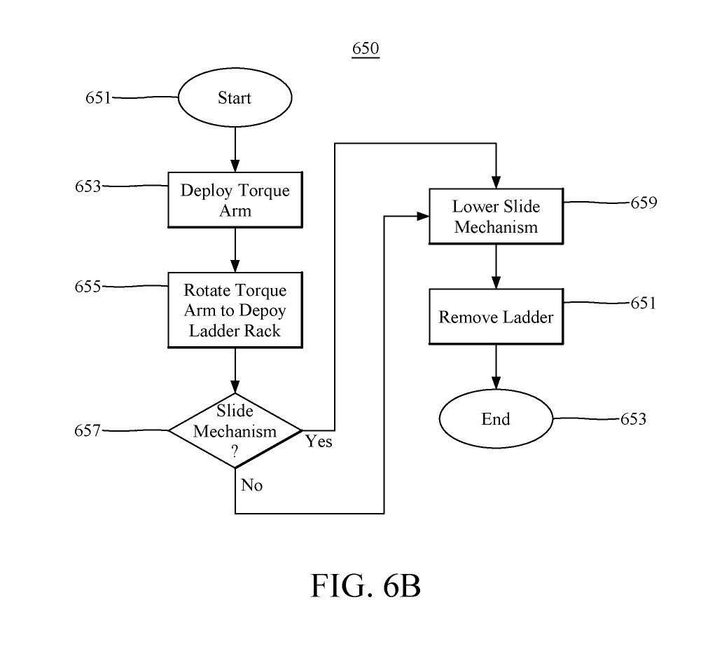

FIGS. 6A and 6B provide two flowcharts for a method of using a ladder rack system according to various embodiments disclosed herein. FIG. 6A provides a flowchart for a method of securing a ladder onto a two module ladder rack and raising it to the top of a vehicle. The method begins at block 601 and proceeds to block 603 where the user lowers the ladder rack to the deployed (down) position. If the ladder rack is equipped with a slide mechanism, the slide mechanism may be lowered at this point. In block 605 the user secures the ladder on the ladder rack. This is done by placing the ladder on the front module and the rear module so that it spans the two modules. The frame of the ladder is placed on the link arm L3 of each module against the alignment tabs.

The ladder restraining brackets 113 and 115 are provided on link arm L3 to aid in securing the ladder to the ladder rack. In some situations the ladder may be fastened to the ladder rack with tie downs, adjustable nylon straps, bungee cords, ropes or the like to even more securely fasten the ladder to the ladder rack. This may be done prior to a long trip or when high winds or rough roads are anticipated. Once the ladder is secured to the ladder rack the method proceeds to block 607.

In block 607 it is determined whether the rack has a slide mechanism or not. If the ladder does have a slide mechanism the method proceeds to block 609 where the user lifts the slide mechanism to the contracted position. The method then proceeds to block 611. If there is no slide mechanism on the ladder rack the method proceeds directly from block 607 to 611. In block 611 the user deploys the torque arm. The torque arm is a handle used to rotate the shaft passing through the fixed rotational connection point H₁, which in turn rotates link arm L1 and all the rotatable parts of the ladder rack. In some embodiments the torque arm folds away to a stowed position for transport. In other embodiments the torque arm may be removed when not in use. Once the torque arm has been deployed—either by unfolding it or attaching it—the method proceeds from block 611 to block 613.

In block 613 the user manipulates the torque arm to raise the ladder rack. In various embodiments this is done manually by the user with the torque arm. Some embodiments rely on motorized power rather than a torque arm to raise the ladder rack. In such embodiments the user manipulates the control for the motor in block 613 to raise the ladder rack. The method proceeds to block 615, assuming the embodiment with a torque arm is being used. In block 615 the user secures the torque arm for travel. In some embodiments this is done by snapping or tying it into a predefined place that secures the torque arm to the vehicle. In other embodiments the user removes the torque arm and stows it within the vehicle. Once the torque arm has been secured the method proceeds to block 617 and ends.

FIG. 6B provides a flowchart for a method of removing a ladder from a ladder rack in the stowed position on the top of a vehicle. The method begins at block 651 and proceeds to block 653 where the torque arm is deployed. In embodiments where the torque arm is folded away to a stowed position for transport, the user simply applies (reduced) torque to deploy just the ladder rack. In those embodiments in which the torque arm is removed when not in use, the user affixes the torque arm to the ladder rack mechanism. Once the torque arm has been deployed the method proceeds from block 653 to block 655.

In block 655 the user manipulates the torque arm to deploy the ladder rack. In embodiments with motorized power the user manipulates the control for the motor in block 655 to lower the ladder rack. As the ladder rack is being deployed it reaches a tipping point. Past the tipping point the force of gravity takes over, and the ladder rack would lower on its own if not for the user maintaining control of the torque arm. In various embodiments a damping mechanism is provided to prevent the ladder rack from falling to quickly. Once the ladder rack has rotated to the deployed position in block 655, the method proceeds to block 657 to determine whether there is a slide mechanism that allows the ladder to be further lowered. Slide mechanisms are typically used for ladder racks mounted on very tall vehicles (e.g., eighteen wheeled trucks, marine vessels, train cars, etc.). If there is a slide mechanism the method proceeds to block 659 to lower it to a convenient for the user.

If there is no slide mechanism as determined in block 657 or if block 659 has been completed, the method proceeds to block 651 where the user removes the ladder from the ladder rack. In some instances the ladder may be tied or otherwise fastened to the ladder rack to make it more secure for travel. In such instances the user releases the tie downs or other fasteners to enable removal of the ladder. Once the ladder has been removed from the ladder rack the method proceeds to block 653 and ends.

Various activities may be included or excluded as described above, or performed in a different order as would be known by one of ordinary skill in the art, while still remaining within the scope of at least one of the various embodiments. For example, in ladder rack embodiments equipped with a slide mechanism is not necessary to lower the slide mechanism in order to remove the ladder. Hence, in FIG. 6B block 659 can be excluded, causing the user to reach a bit higher in order to access the ladder. Similarly, block 607 of FIG. 6A and block 657 of FIG. 6B need not be performed in the sequence depicted in the flowchart. One of ordinary skill in the art would know that blocks 607 and 657 may be performed in any sequence ahead of blocks 609 and 659, respectively. Also, the claims recited “placing a first end of the lengthy object on a front ladder restraining bracket” and “placing a second end of the lengthy object on a rear ladder restraining bracket.” The claims are intended to encompass either the first end being placed first, the second end being placed first, or the two ends being placed simultaneously on the restraining brackets.

The description of the pivot points A, B, C, H₁ and H₂ in conjunction with FIG. 1A stated that the various pivot points have rotational elements—e.g., bearings—to effect the relative rotation of the link arms. The bearing may be ball bearing assemblies or roller bearing assemblies. Other rotational elements aside from bearings may be used, including for example, hinge assemblies, pin and hole mechanisms, flexible straps, ball joints, universal joints or other like types of rotational elements known by those of ordinary skill in the art. In the figures included herein that illustrate various embodiments the link aims are depicted as being straight. In practice, however, the link arms need not be straight. The link arms may be curved or angled to suit various applications, e.g., to conform to the shape of the vehicles roof. In the figures contained herein that illustrate two modules, the modules are depicted as having the same or similar dimensions. In practice, however, various embodiments are provided in which the dimensions of the two modules are different for diversification of application. For example, in one embodiment the dimensions of one or more of the link arms L1-L4 are longer in the rear module than in the front module. In this way the deployment position of the rear module is lower, and thus more convenient to the user, than the deployment position of the front module. Other embodiments are provided in which the various link arms vary in length in the front module as compared to the rear module, e.g., to provide a lower deployment position in the front as compared to the rear.

The descriptions contained in this disclosure are written in terms of stowing and transporting ladders. However, the various “ladder” rack embodiments may be used to stow and transport other types of lengthy objects such as materials and/or equipment. For example, various ladder rack embodiments disclosed herein may stow and transport lengthy objects such as lumber, pipes, braces, fencing and other such building materials; concrete forms, shovels, rakes and other such tools; fishing poles, pole vault poles, skis and other such sports equipment; bicycles, scooters, wheel chairs, snow mobiles, and other such small vehicles; canoes, kayaks, surf boards, windsurfing sailboards and other such sports devices; or other like types of materials or equipment that are known to those of ordinary skill in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises,” “comprising,” “includes,” and/or “including” used in this specification specify the presence of stated features, integers, steps, operations, elements, and/or components, but do not preclude the presence or addition of one or more other features, integers, steps, operations, elements, components, and/or groups thereof. The term “plurality”, as used herein and in the claims, means two or more of a named element. It should not, however, be interpreted to necessarily refer to every instance of the named element in the entire device. Particularly, if there is a reference to “each” element of a “plurality” of elements. There may be additional elements in the entire device that are not be included in the “plurality” and are not, therefore, referred to by “each.” The term “substantially” (e.g., substantially vertical or substantially one foot) as used herein in the specification and claims is meant to mean plus or minus as much as 2%. For example, substantially one foot as used herein means any length within the range of 1 foot+/−0.02 foot. Similarly, an angle of 10 degrees as used herein means any angle within the range of 10 degrees+/−0.2 degree. The word “incline” (or “inclined”) means angled from a line, direction, component, surface or the like. For example, the phrase “inclined 15 degrees from vertical” as used herein means “angled 15 degrees from vertical”. The phrase fixed rotation point on the housing means that the housing has attached to it bearings or other like types of rotational connection point structures that allow a link arm (e.g., link arm L4) to be rotatably connected to the housing. The word “stowing” means holding. A ladder stowed on a vehicle is held on the vehicle.

The corresponding structures, materials, acts, and equivalents of all means or step plus function elements, if any, in the claims below are intended to include any structure, material, or act for performing the function in combination with other claimed elements as specifically claimed. This disclosure of the various embodiments has been presented for purposes of illustration and description, and is not intended to be exhaustive in the form disclosed. Many modifications and variations will be apparent to those of ordinary skill in the art without departing from the scope and gist of the invention. The various embodiments included herein were chosen and described in order to best explain the principles of the invention and the practical application, and to enable others of ordinary skill in the art to understand the invention for various embodiments with various modifications as are suited to the particular use contemplated. The description of the various embodiments provided above is illustrative in nature inasmuch as it is not intended to limit the invention, its application, or uses. Thus, variations that do not depart from the intents or purposes of the invention are encompassed by the various embodiments of the present invention. Such variations are not to be regarded as a departure from the intended scope of the present invention.

What is claimed:

1. A ladder storage rack for stowing a lengthy object on a vehicle, the ladder storage rack comprising:
a front module for holding a first end of the lengthy object, the front module comprising a front housing, at least four front module link arms and at least five front module rotation points, wherein the at least five front module rotation points comprise a first front fixed rotation point and a second front fixed rotation point on the front housing;
a rear module for holding a second end of the lengthy object, the rear module comprising a rear housing, at least four rear module link arms and at least five rear module rotation points, wherein the at least five rear module rotation points comprise a first rear fixed rotation point and a second rear fixed rotation point on the rear housing;
the front housing being affixed to the vehicle, wherein a first front module link arm of the at least four front module link arms is rotatably connected to the first front fixed rotation point on the front housing;
the rear housing being affixed to the vehicle, wherein a first rear module link arm of the at least four rear module link arms is rotatably connected between the first rear fixed rotation point on the rear housing and a rear module pivot point on a second rear module link arm;
a plurality of brackets for holding the lengthy object; and
a rotatable tube connecting the rear module to the front module.

2. The ladder storage rack of claim 1, the plurality of brackets comprising:
a front ladder restraining bracket included as part of the front module for holding the first end of the ladder; and
a rear ladder restraining bracket included as part of the rear module for holding the second end of the ladder.

3. The ladder storage rack of claim 2, wherein a second front module link arm of the at least four front module link arms is rotatably connected to the second front fixed rotation point on the front housing; and
wherein a second rear module link arm of the at least four rear module link arms is rotatably connected to the second rear fixed rotation point on the rear housing.

4. The ladder storage rack of claim 2, wherein the rear module and the front module of the ladder storage rack are configured to be manipulated along a curvilinear path of the ladder rack between a stowed position and a deployed position; and
wherein the stored position stores said lengthy object on top of the vehicle and the deployed position provides the lengthy object lower over a side of the vehicle to ease removal of the lengthy object from the ladder storage rack.

5. The ladder storage rack of claim 4, wherein movement of the ladder rack between the stowed position and the deployed position is characterized by a drop d conforming to a relationship of:
d=L_{B} cos(δ)+cos(α)L_{F}
wherein the L_{F} variable is a length between the first rear fixed rotation point on the rear housing and a distal end of the first rear module link arm, wherein the L_{B} variable is a distance between the first rear fixed rotation point and the rear module pivot point, wherein an the δ variable is an angle that the first rear module link arm is inclined from vertical with the ladder storage rack in the deployed position, and wherein the α variable is an angle the second rear module link arm is inclined from vertical with the ladder storage rack in the deployed position.

6. The ladder storage rack of claim 2, wherein each of the at least five rear module rotation points rotates about an axis in common with a corresponding one of the at least five front module rotation points.

7. The ladder storage rack of claim 1, wherein a tipping position is located between the stowed position and a deployed position, user effort being required to move the rear and front modules from the stowed position to the tipping position, and gravity being sufficient to move the rear and front modules from the tipping position to the deployed position.

8. The ladder storage rack of claim 7, further comprising:
a torque arm connected to the rotatable tube;
wherein the user effort is force applied by the user to the torque arm.

9. The ladder storage rack of claim 7, further comprising:
wherein a first one of the at least four front module link arms is rotatably connected to a third fixed rotation point on the front housing and a second one of the at least four front module link arms is rotatably connected to a fourth fixed rotation point on the front housing.

10. The ladder storage rack of claim 1, wherein the lengthy object is a ladder;
wherein said at least four rear module link arms and said at least four front module link arms are rotatable link arms; and
wherein each of the at least four rear module link arms is a same length as each corresponding one of the at least four front module link arms.

11. The ladder storage rack of claim 2, further comprising:
a reflex locking mechanism configured to secure the ladder storage rack in place upon reaching a stowed position;
wherein the reflex locking mechanism released the ladder rack from the stowed position in response to force applied to a torque arm connected to the rotatable tube of the ladder storage rack.

12. The ladder storage rack of claim 2, further comprising:
a slide mechanism comprising a first member attached to the rear module and a second member attached to the front module, the slide mechanism being configured to be lowered in response to the ladder storage rack reaching a deployed position.

13. A method of stowing a lengthy object on a ladder storage rack attached to a vehicle, the method comprising:
affixing a torque arm to a rotatable tube connecting a rear module of the ladder storage rack to a front module of the ladder storage rack;
lowering the ladder storage rack to a deployed position;
placing a first end of the lengthy object on a front ladder restraining bracket included as part of the front module of the ladder storage rack;
placing a second end of the lengthy object on a rear ladder restraining bracket included as part of the rear module of the ladder storage rack;
applying force to the torque arm, the force being sufficient to lift the rear and front ladder rack modules along a curvilinear path of the ladder rack to a tipping point, the tipping point being a balanced position where gravity pulling the rear and front ladder rack modules towards a stowed position is equal to the gravity pulling the rear and front ladder rack modules toward the deployed position; and
moving the torque arm to manipulate the rear and front ladder rack modules further along the curvilinear path of the ladder rack from the tipping point to the stowed position atop a roof of the vehicle.

14. The method of claim 13, wherein the lengthy object is a ladder; and
wherein the force applied to the torque arm is applied by the user to the torque arm.

15. The method of claim 13, further comprising:
latching a reflex locking mechanism to secure the ladder storage rack in place in the stowed position;
wherein the reflex locking mechanism latches in response to the rear and front ladder rack modules reaching the stowed position.

16. The method of claim 13, wherein the ladder storage rack is configured according to claim 1.
